(19) United States
(12) Patent Application Publication
(10) Pub. No.: US 2026/0243272 A1
(43) Pub. Date: Aug. 20, 2026

(54) INLET NOZZLE FOR FANS

(71) Applicant: ZIEHL-ABEGG SE, Künzelsau (DE)

(72) Inventors: Dennis BULLINGER, Dörzbach (DE); Matthias GÖLLER, Weißbach (DE); Jürgen REHRAUER, Schöntal-Sindeldorf (DE)

(73) Assignee: ZIEHL-ABEGG SE, Künzelsau (DE)

(21) Appl. No.: 19/472,154

(22) PCT Filed: Mar. 28, 2024
(86) PCT No.: PCT/EP2024/058677

§ 371 Date: Oct. 3, 2025

(30) Foreign Application Priority Data
Apr. 6, 2023 (DE) 10 2023 001 453.2

(51) Int. Cl. F04D 29/40

(52) U.S. Cl. CPC F04D 29/403

(57) ABSTRACT

An inlet nozzle for fans has a securing part (1) and an annular wall (3) connected to it, on which at least one protruding pressure connection (18) is provided. In order to be able to provide the pressure connection (18) in a more simple and reliable manner and at low cost, it is formed as a single piece with the inlet nozzle. In this way, additional assembly steps for attaching the pressure connection (18) can be avoided. The pressure connection (18) is provided directly during the manufacturing of the inlet nozzle. This avoids manufacturing and assembly costs as well as possible rejects due to the assembly process. No assembly devices are required, which would lead to increased costs of manufacturing the inlet nozzle. Given that the pressure connection (18) is part of the inlet nozzle, no additional storage locations need to be provided for the pressure connections (18).

### CROSS-REFERENCE TO RELATED APPLICATION

This application is a national stage application, filed under 35 U.S.C. § 371, of International Patent Application PCT/EP 2024/058677, filed on Mar. 28, 2024, which claims the benefit of German Patent Application DE 10 2023 001 453.2, filed on Apr. 6, 2023.

### TECHNICAL FIELD

The disclosure relates to an inlet nozzle for fans.

### BACKGROUND

There is often a need to measure pressure in fan inlet nozzles. To this end, the medium flowing through the inlet nozzle, generally air, is drawn in over a certain contour/angle. At least one pressure port is provided for this purpose, which constitutes a type of valve via which the pressure of the medium flowing through the inlet nozzle is recorded. The flow volume of the medium can be calculated using the pressure. A blind rivet nut with a hose connector is riveted to the annular wall of the inlet nozzle as a pressure port. In a further known embodiment, a straight screw-in connector is screwed into a blind rivet nut with a round shank. In both cases, an additional mounting process is required during production of the inlet nozzle in order to fix the pressure port to the annular wall. Mounting the pressure port is not a reliable process, because the riveting can lead to problems. For instance, cracks can form on the inlet nozzle in the region of the pressure port. They are due to the fact that the material of the inlet nozzle deforms and strong forces occur in the hole region at which the pressure port is fixed, said forces leading to crack formation on the inlet nozzle. In addition, the pressure port frequently does not rest perfectly against the contour of the inlet nozzle, as the latter is usually curved. The additional mounting process and drilling of the hole in order to insert the pressure port incur considerable extra costs. In addition, this makes mounting complicated and prone to errors.

### SUMMARY

The disclosure is based on the object of designing an inlet nozzle for a fan such that a pressure port can be provided simply, reliably and cost-effectively.

This object is solved by the inlet nozzle as described and claimed.

In the inlet nozzle, the pressure port is made as a single piece with the inlet nozzle. As a result, no additional mounting steps are needed to fix the pressure port. The pressure port is provided directly during manufacture of the inlet nozzle. As a result, manufacturing and mounting costs as well as possible rejects owing to the mounting method are avoided. There is no need for any mounting apparatus, which would make production of the inlet nozzle more expensive. Since the pressure port is part of the inlet nozzle, no additional storage space needs to be reserved for the pressure ports.

Advantageously, the inlet nozzle with pressure port is made as a single-piece injection-moulded part. The inlet nozzle can therefore be produced very easily and cost-effectively with suitable plastics in the injection-moulding process.

In another advantageous embodiment, the inlet nozzle with pressure port is made as a single-piece pressure-die-cast part. For example, aluminium can be used as material for the inlet nozzle.

Both the injection moulded part and the pressure-die-cast part have the advantage that the inlet nozzle can be produced together with the pressure port in a single process or in a single shot. After removal of the inlet nozzle from the corresponding mould, the inlet nozzle is ready for use and does not subsequently need to be provided with the pressure port.

The pressure port advantageously has a passage that widens towards the outlet opening or the inlet opening. Owing to this shape of the passage, simple removal from the respective mould is ensured.

To this end, it is advantageous if the pressure port has an outer side that tapers preferably conically towards the outlet opening.

Advantageously, the outer side of the pressure port can have two outer side sections with different outer diameters. As a result, it is possible on the one hand to make the pressure port very strong at the transition to the annular wall of the inlet nozzle. On the other hand, the outer diameter of the pressure port can be selected so that standardised pressure measuring hoses can be attached to the pressure port. The section of smaller outer diameter extends from the outlet opening of the pressure port towards its inlet opening.

Advantageously, the outer side sections transition into each other via a radial circumferential shoulder. When the pressure measuring hose is attached, this shoulder can then serve as a stop, up to which the pressure measuring hose is able to be pushed onto the pressure port.

The transition region from the pressure port into the annular wall of the inlet nozzle is advantageously designed bionically using a method of tensile triangles. As a result, a great degree of strength can be achieved at the transition region from the pressure port into the annular wall of the inlet nozzle.

### BRIEF DESCRIPTION OF THE DRAWINGS

The invention is explained in more detail with reference to an exemplary embodiment illustrated in the drawings:

FIG. 1 shows a perspective illustration of an inlet nozzle.

FIG. 2 shows partially in side view and partially in axial section, the inlet nozzle according to FIG. 1.

FIG. 3 shows an enlarged and perspective illustration of a part of the inlet nozzle having a pressure port.

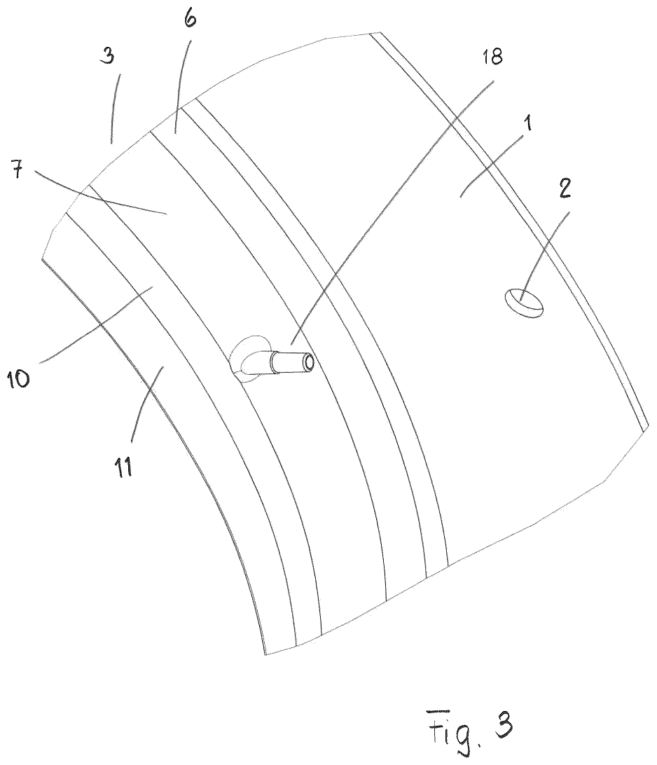

FIG. 4 shows a section through the pressure port as per FIG. 3 in an enlarged illustration.

### DETAILED DESCRIPTION

The inlet nozzle is provided for a fan, preferably a radial fan.

The inlet nozzle has a fastening flange 1 which is circular in the exemplary embodiment. Depending on the intended use and design of the fan, the fastening flange 1 can also have another profile, for example an oval or angled profile. Fastening openings 2 for screws and the like, with which the inlet nozzle can be fastened to a wall, for example, are advantageously provided uniformly distributed around the circumference of the fastening flange 1.

The fastening flange 1 surrounds an annular wall 3 which is advantageously formed as a single piece with the fastening flange 1.

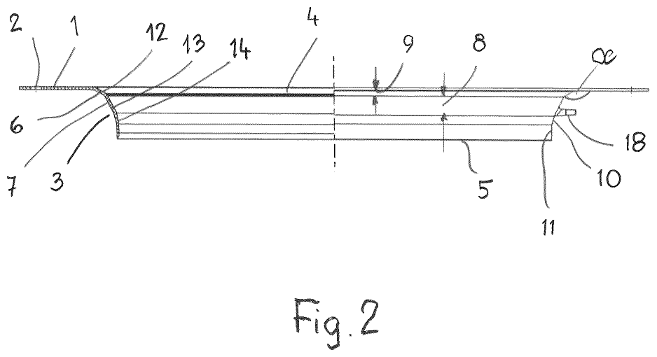

The fastening flange 1 lying in a radial plane surrounds an inlet opening 4 (FIG. 2), via which the impeller of the fan sucks in air. This air flows through the inlet nozzle and reaches the impeller of the fan via an outlet opening 5 in a known manner.

The inlet opening 4 is bordered by a conical annular wall 6 that tapers towards the outlet opening 5. The wall 6 connects the fastening flange 1 to an annular intermediate wall 7 that adjoins the conical wall 6 at an obtuse angle (FIG. 2).

The conical wall 6 adjoins the fastening flange 1 at a larger obtuse angle than the intermediate wall 7 (FIG. 2). In the axial direction, the conical wall 6 is advantageously smaller than the intermediate wall 7, the axial width 8 of which is, for example, two to five times wider than the axial width 9 of the conical wall 6.

The intermediate wall 7 transitions at an obtuse angle into a transition wall 10 adjoined by an end wall 11. The transition wall 10 is conical in design and is at a larger obtuse angle to the fastening flange 1 than the intermediate wall 7. The end wall 11 is cylindrical and is therefore at a right angle to the fastening flange 1, as seen in the axial section.

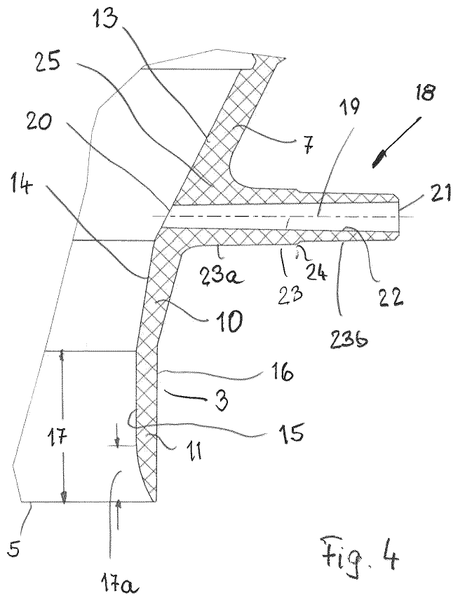

The walls 6, 7 and 10 each have conical inner sides 12 to 14. The end wall 11 has a cylindrical inner side 15, the inner diameter of which widens near the outlet opening 5, preferably continuously (FIG. 4). The outer side 16 of the end wall 11 extends over the entire axial width 17 cylindrically.

Owing to the described design, the wall thickness of the end wall 11 decreases towards the outlet opening 5. Advantageously, the wall thickness decreases over an axial width 17a, which is advantageously smaller than half the axial width 17 of the end wall 11.

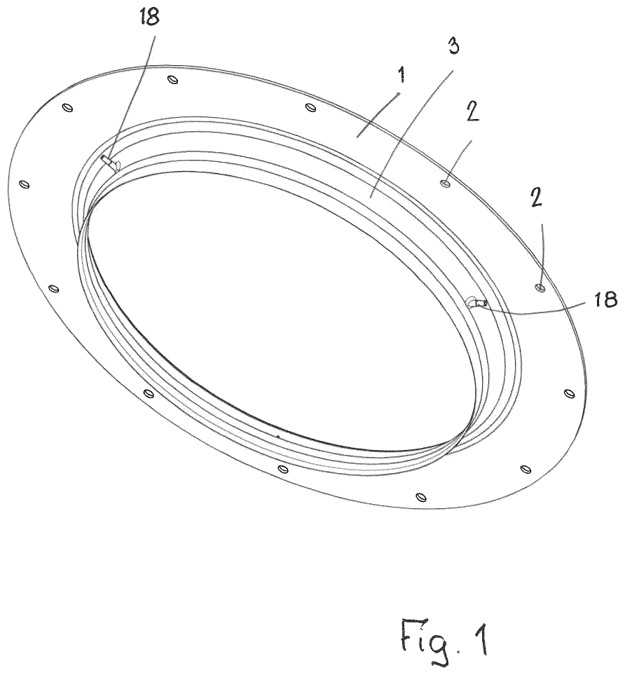

Provided on the annular wall 3 is at least one pressure port 18, which is provided on the outer side of the annular wall 3 and extends outwards. As FIG. 1 shows, two or even more pressure ports 18 can be provided on the annular wall 3.

The pressure port 18 is used to record the amount of medium flowing through the inlet nozzle to the fan. Using the pressure port 18, the pressure of the medium flowing through the inlet nozzle can be recorded in a known manner and the flow volume calculated therefrom.

The pressure port 18 is formed as a single piece with the annular wall 3. As a result, there is no need for an additional mounting process for the pressure port 18.

By way of example, the pressure port 18 is provided at the transition from the intermediate wall 7 to the transition wall 10 (FIG. 4). The pressure port 18 is designed as a nozzle with an annular profile.

The pressure port 18 has a continuous opening 19 that opens into the inner side 13 of the intermediate wall 7.

The opening 19 has a conical design such that the cross-section of the opening 19 widens continuously from the inlet opening 20 in the inner side 13 of the intermediate wall 7 up to the outlet opening 21 of the pressure port 18. The inner wall 22 of the opening 19 thus lies on a cone-shaped surface and has no interruptions.

The outer side 23 of the pressure port 18 is likewise of conical design, with the outer diameter of the outer side 23 increasing from the outlet opening 21.

In the exemplary embodiment, the pressure port 18 has two outer side sections 23a and 23b of different diameter. The two outer side sections 23a, 23b transition into each other via a circumferential shoulder face 24. Each outer side section 23a, 23b is conical on the outside, with the outer diameter of both outer side sections 213a, 23b increasing towards the intermediate wall 7. The outer side section 23b of smaller outer diameter extends outwards from the outlet opening 21. At about half the length of the pressure port 18, the outer side section 23b transitions via the shoulder face 24 into the outer side section 23a of larger diameter.

So that the pressure port 18 has sufficient strength at the transition to the annular wall 3, the transition 25 to the intermediate wall 7 and the transition wall 10 of the annular wall 3 is given a bionic radius. Said radius can be created in a known manner, for example by an assembly using tension triangles. Using the tension triangles, the shape of notches can be optimised in a known manner so that the stress concentrations thereon are reduced such that excessively high notch stresses which would damage the pressure port 18 are avoided.

The transition region 25 is designed such that the material thickness at the transition from the annular wall 3 to the pressure port 18 has a sufficiently great wall thickness.

During the pressure measuring, a hose is pushed onto the pressure port 18. If the pressure port 18, as in the described and shown exemplary embodiment, has the shoulder face 24, the hose is pushed on so far until it rests against this shoulder face 24.

The inlet nozzle including the pressure port 18 is produced in one piece in an injection mould from a suitable plastic. Since the pressure port 18 has the conical outer side 23 and the conical opening 19, simple demoulding from the injection mould is ensured. Materials considered for use for the inlet nozzle include, for example, plastics, such as PA, ABS or the like, or aluminium.

In principle, the inlet nozzle can also be integrally produced from aluminium in a die-casting process. In this case as well, the described shaping of the pressure port 18 enables simple demoulding of the inlet nozzle from the die-casting mould.

The inlet nozzle can thus be produced completely in one shot.

No subsequent mounting measures are needed in order to create the pressure port 18. The pressure port 18 is integrated in the inlet nozzle, meaning that the complete inlet nozzle can be produced easily and subsequently mounted. In particular, no mounting apparatus is needed to mount the pressure port on the inlet nozzle. Accordingly, there is no need for any storage space, as is needed with known pressure ports for the various parts of the pressure port.

1-8. (canceled)

9. An inlet nozzle for a fan, comprising:
a fastening part (1);
an annular wall (3) connected to the fastening part (1); and
at least one protruding pressure port (18) provided on the annular wall (3), wherein the pressure port (18) is made as a single piece with the inlet nozzle.

10. The inlet nozzle according to claim 9,
wherein the inlet nozzle with pressure port (18) is made as a single-piece injection-moulded part.

11. The inlet nozzle according to claim 9,
wherein the inlet nozzle with pressure port (18) is made as a single-piece pressure-die-cast part.

12. The inlet nozzle according to claim 9,
wherein the pressure port (18) has a passage (19) that widens towards an outlet opening (21) or an inlet opening (20).

13. The inlet nozzle according to claim 9,
wherein the pressure port (18) has an outer side (23) that tapers conically towards an outlet opening (21).

14. The inlet nozzle according to claim 13,
wherein the outer side (23) has two outer side sections (23a, 23b) with different outer diameters.

15. The inlet nozzle according to claim 14,
wherein the outer side sections (23a, 23b) transition into each other via a radial circumferential shoulder (24).

16. The inlet nozzle according to claim 9,
wherein a transition region (25) in the annular wall (3) is designed bionically using a method of tensile triangles.
